(19) United States
(12) Patent Application Publication
(10) Pub. No.: US 2015/0369462 A1
(43) Pub. Date: Dec. 24, 2015

(54) Light Bulb Receptacles and Light Bulb Sockets

(71) Applicant: Ken Smith, Kellogg, ID (US)

(72) Inventors: Ken Smith, Kellogg, ID (US); John U. Jansen, Kellogg, ID (US)

(21) Appl. No.: 14/464,625

(22) Filed: Aug. 20, 2014

Related U.S. Application Data
(60) Provisional application No. 62/015,919, filed on Jun. 23, 2014.

(51) Int. Cl. F21V 21/002; F21V 23/06

(52) U.S. Cl. CPC F21V 21/002; F21V 23/06; F21Y 2101/00

(57) ABSTRACT

Light bulb receptacles and light bulb sockets are described. According to one aspect, a light bulb receptacle includes a housing which defines a housing chamber, a light bulb socket within the housing chamber and which comprises a first end and a second end about a light bulb chamber which is configured to receive a base of a light bulb, wherein the light bulb socket further comprises a plurality of fingers which extend outwardly from the first end toward the second end and define an opening to the light bulb chamber at the second end, wherein the fingers are individually configured to move outwardly from the light bulb chamber during insertion and removal of the light bulb via the opening to the light bulb chamber, and wherein the fingers individually comprise an engagement member configured to engage a base of the light bulb received within the light bulb chamber and to retain the light bulb received within the light bulb chamber.

### RELATED PATENT DATA

This application claims priority to U.S. Provisional Patent Application Ser. No. 62/015,919, entitled “Light Bulb Receptacles and Light Bulb Sockets,” which was filed Jun. 23, 2014, and the teachings of which are incorporated herein by reference.

### TECHNICAL FIELD

This disclosure relates to light bulb receptacles and light bulb sockets.

### BACKGROUND OF THE DISCLOSURE

Electric light bulbs are ubiquitous for countless uses and applications. Electric light bulbs typically have a fixed life and require replacement. Some conventional light bulbs have a threaded base, and accordingly, these light bulbs may be screwed into a corresponding light fixture having a threaded receiver.

At least some aspects of the disclosure are directed towards apparatus and methods for facilitating insertion or removal of light bulbs with respect to light bulb receptacles.

### BRIEF DESCRIPTION OF THE DRAWINGS

Example embodiments of the disclosure are described below with reference to the following accompanying drawings.

FIG. 1 is an illustrative view of one embodiment of a light bulb receptacle and light bulb according to one embodiment.

FIG. 2 is an exploded illustrative view of a light bulb and light bulb receptacle according to one embodiment.

FIG. 3 is a top view of a light bulb socket according to one embodiment.

FIG. 4 is an isometric view of a light bulb socket according to one embodiment.

FIG. 5 is an exploded illustrative view of a light bulb and components of a light bulb receptacle according to one embodiment.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

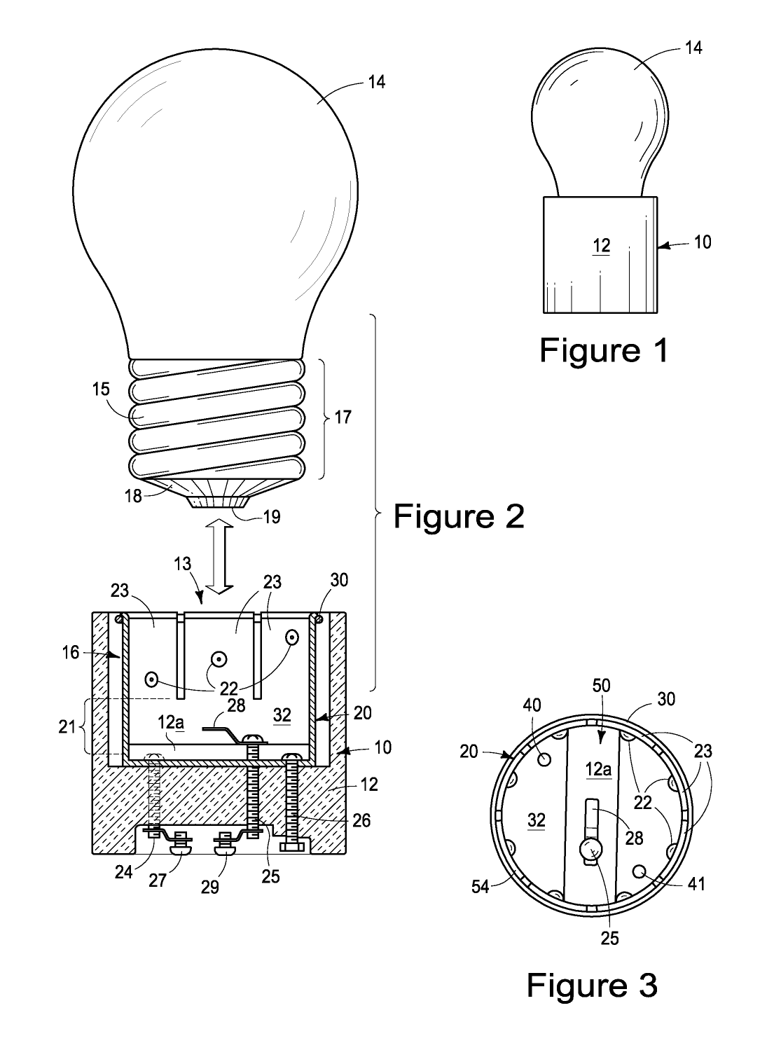

FIG. 1 illustrates a light bulb receptacle 10 coupled with a light bulb 14 according to one embodiment of the disclosure. As described further below, light bulb 14 may include a threaded base which is received within a housing 12 (and socket 20 as shown in FIG. 2) of light bulb receptacle 10 according to one embodiment. In one embodiment, light bulb 14 may be rotated with respect to housing 12 and socket 20 to insert or remove light bulb 14 with respect to light bulb receptacle 10. As described further below, light bulb 14 may also be inserted or removed from light bulb receptacle 10 without rotation (e.g., in a linear direction) in one embodiment.

Referring to FIG. 2, additional details of an example embodiment of light bulb receptacle 10 are shown. The housing 12 is electrically insulative and defines a housing chamber 16 in the illustrated embodiment. An entirety of housing 12 is a unitary single member of a monolithic electrically insulative material, such as plastic or ceramic, in example embodiments.

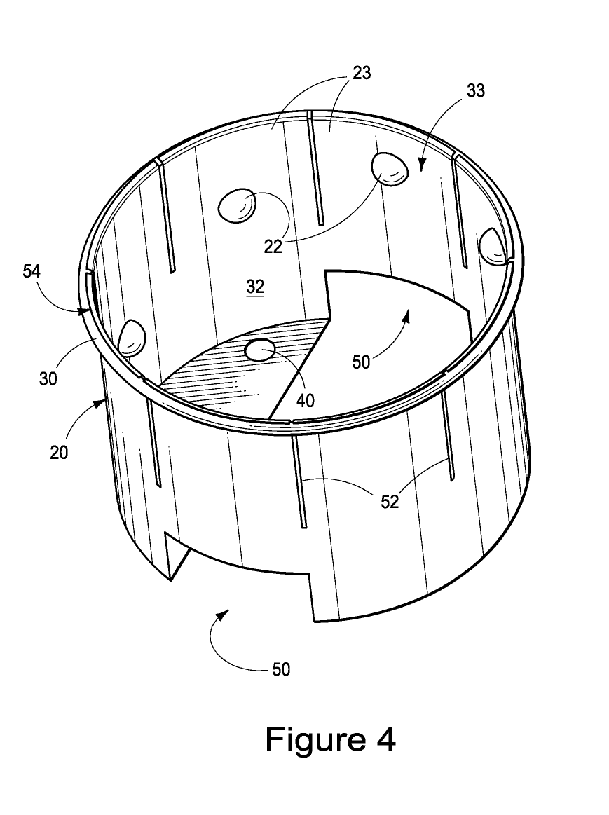

In one embodiment, a first end of housing 12 is substantially enclosed and defines housing chamber 16 which is configured to receive a light bulb socket 20 described further below. A second end of housing 12 defines an opening 13 with respect to housing chamber 16. In one embodiment, housing 12 includes an extended portion 12a which engages a slot within the light bulb socket 20 as described below (an embodiment of the socket 20 including a slot is shown FIGS. 3 and 4). In one embodiment, extended portion 12a elevates terminal connector 28 above first end of socket 20 to further isolate terminal connector 28 from socket 20.

Light bulb socket 20 is received within the housing chamber 16 of housing 20 according to one embodiment. Light bulb socket 20 may be electrically conductive in some embodiments and may be electrically connected with a terminal of light bulb 14. For example, light bulb socket 20 may be copper or other conductive metal in more specific examples. As described below, socket 20 is configured to engage threads 15 of a threaded base 17 of light bulb 14 received within socket 20 in one implementation and to retain the threaded base 17 of light bulb 14 within housing 12.

Light bulb socket 20 is cylindrical and includes a plurality of fingers 23 which extend upwardly from proximal ends adjacent to a solid circular ring portion 21 of socket 20 towards distal ends adjacent to opening 13 in one embodiment. Ring portion 21 and fingers 23 define a light bulb chamber 32 which receives threaded base 17 of light bulb 14 and an opening 33 to chamber 32 (see FIG. 4) through which the threaded base 17 may be inserted or removed. Light bulb socket 20 including ring portion 21 and fingers 23 is a single unitary member of a monolithic electrically conductive material (e.g., copper) in the illustrated embodiment.

Fingers 23 individually include one or more engagement members 22 which are spaced from one another at different circumferential locations of light bulb socket 20 in the example arrangement shown in FIG. 2. Engagement members 22 are configured to engage and retain a threaded base 17 of light bulb 14 within housing 12 of light bulb receptacle 10 in one embodiment. In particular, the engagement members 22 may engage threads 15 of threaded base 17 to retain the light bulb 14 within housing 12 in one embodiment described in further detail below.

Threaded base 17 may be one electrical terminal of an example light bulb 14. As mentioned above, light bulb socket 20 may be electrically conductive in one embodiment and the electrically conductive engagement members 22 and fingers 23 thereof may provide electrical connection between the light bulb receptacle 10 and the threads 15 of light bulb 14 upon insertion of light bulb 14 into light bulb socket 20. In one embodiment, threaded base 17 is a negative terminal of light bulb 14.

Light bulb receptacle 10 also includes a plurality of connection members 24, 25, 26 which secure the light bulb socket 20 to the housing 12. In one embodiment, connection members 24, 25, 26 are electrically conductive and may be implemented as metal bolts or screws.

A first end of connection member 24 is electrically coupled with light bulb socket 20 (similar to connection member 26) and a second end thereof is coupled with a negative lead connector 27. Accordingly, in one embodiment, socket 20, member 24 and connector 27 provide electrical connection with the negative terminal (i.e., threaded base) of the light bulb 14 inserted into socket 20. A negative wire may be coupled with negative lead connector 27 and an electrical power source (the negative wire and electrical power source are not shown) in one embodiment.

A first end of connection member 25 is coupled with a terminal connector 28 which is configured to provide electrical connection with a positive terminal 19 of light bulb 14 upon insertion of threaded base 15 of light bulb 14 into light bulb socket 20. A second end of connection member 25 is coupled with a positive lead connector 29 which may be coupled with a positive wire and electrical power source (not shown).

Connection member 26 operates to secure light bulb socket 20 and housing 12 together and may also be utilized as a connection to the negative terminal of light bulb 15.

As described further below, one embodiment of light bulb receptacle 10 permits light bulbs 14 to be inserted into socket 20 and removed from socket 20 in a linear and/or rotational manner. For example, the engagement members 22 are positioned in locations which correspond to threads 15 of light bulb 14 and allow light bulb 14 to be rotated in opposing directions for insertion or removal of the light bulb 14 with respect to socket 20. In one more specific embodiment, the engagement members 22 are spaced at different distances from a common end of socket 20 to define a thread pattern which corresponds to a pattern of threads 15 of light bulb base 17.

If a light bulb 14 is moved linearly (i.e., without rotation) with respect to socket 20, the fingers 23 are individually configured to move outwardly within housing chamber 16 to permit individual threads 15 of base 17 to pass past the engagement members 22. In one embodiment, fingers 23 of light bulb socket 20 have spring properties to return to original inward positions following the insertion or removal of the base 17 of light bulb 14 with respect to light bulb chamber 32 which causes outward movement of the fingers 23. If the base 17 of a bulb 14 is inserted into chamber 32, the fingers 23 may return to the original inward positions where the engagement members 22 engage the threads 15 of base 17 to retain the threaded base 17 within chamber 32 and receptacle 10.

In one embodiment, a retaining member 30 such as a circular spring is provided around the fingers 23 at a location proximate to distal ends of the fingers 23 and the opening 33 to light bulb chamber 32. Retaining member 30 is a spring steel ring in one example embodiment. Retaining member 30 impedes or restricts but allows outward movement of the distal ends of fingers 23 as threads 15 of base 17 pass the engagement members 22 during insertion or removal of the light bulb 14. Retaining member 30 operates to provide a force to urge the distal ends of fingers 23 inwardly after the outward movement, for example, such that engagement members 22 of fingers 23 engage threads 15 of light bulb base 17 to retain light bulb 14 within the receptacle 10.

In one embodiment, retaining member 30 is not continuous about its entire circumference (e.g., an open slot may be provided in the retaining member 30) to permit the retaining member 30 to move outwardly and increase in diameter during passage of threads 15 by engagement members 22 during insertion or removal of light bulb 14 with respect to receptacle 10. The memory properties of the retaining member 30 cause the retaining member 30 to return to the original position having a smaller diameter following the passage of the threads 15 by the engagement members 22 during insertion or removal of the light bulb 14. The engagement members 22 engage the threads 15 and retain the light bulb base 17 within the receptacle 10 following the insertion of the light bulb base 17 into the socket 20.

Referring to FIGS. 3 and 4, additional details regarding light bulb socket 20 are shown in one embodiment. The engagement members 22 are spaced about the circumference of light bulb chamber 32 to engage and retain a threaded base 17 of a light bulb 14 within chamber 32. Light bulb socket 20 includes a slot 50 which receives extended upper portion 12a of housing 12. The connection member 25 and terminal connector 28 are received within slot 50 during coupling of the light bulb socket 20 to the housing 12 and are spaced from socket 20 providing electrical isolation of the connection member 25 and terminal connector 28 from the light bulb socket 20. Retaining member 30 is provided about the distal ends of fingers 23 to urge engagement members 22 inwardly to engage the threads 15 of threaded base 17 received within chamber 32.

In one specific example embodiment, light bulb socket 20 has a diameter of 1.08″ and a height of 0.77″. The engagement members 22 are 0.10″ dimples formed in the fingers 23 and located at 45 degree increments about the chamber 32 and which are spaced at different distances from the distal ends of fingers 23. In one embodiment, the engagement members 22 are individually spaced upwards or downwards from the distal ends of fingers 23 by 0.05″ with respect to adjacent engagement members 22 in a right hand twist in the presently described example. A plurality of slots 52 each having a length of 0.41″ are provided at 45 degree increments about the chamber 32 and define the respective fingers 23 in one configuration.

The distal ends of fingers 23 of the illustrated embodiment have a lip 54 having a 0.05″ quarter diameter radius and the lips 54 of the fingers 23 receive and engage retaining member 30. Retaining member 30 has a thickness (diameter) of 0.02″ and a radius of 0.56″ in the example embodiment. The lip 54 aids with maintaining positioning of the retaining member 30 at the second end of the socket 20 (at the distal ends of fingers 23) to urge the distal ends of fingers 23 inwardly such that the engagement members 22 engage the threads 15 of the threaded base 17 within socket 20. Plural apertures 40, 41 are shown in the depicted embodiment of the socket 20 of FIG. 3 to receive connection members 24, 26.

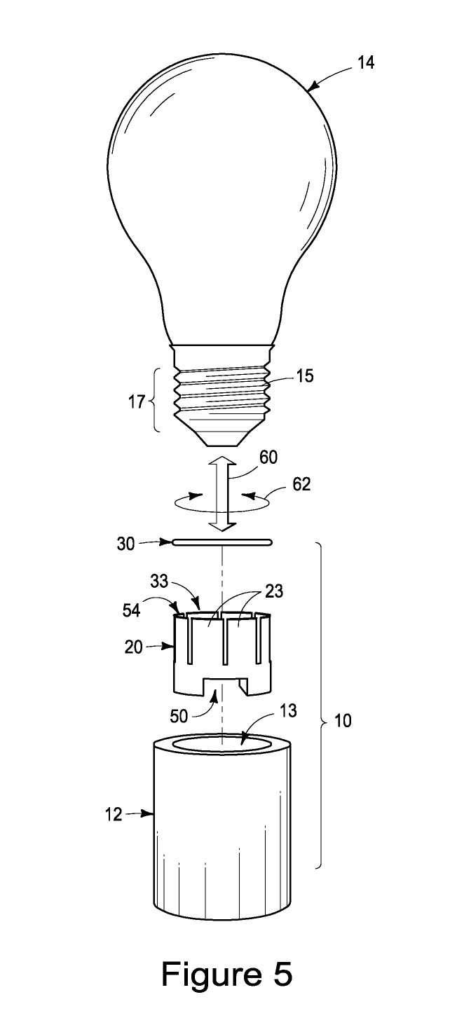

Referring to FIG. 5, light fixture 10 and bulb 14 are shown in an exploded view. For assembly, light socket 20 is inserted into opening 13 and is connected with housing 12 using connection members 24, 26 discussed above. Retaining member 30 is positioned about the distal ends of fingers 23 adjacent to lip 54 to cause engagement members 22 to engage the threads 15 of light bulb 14 inserted into chamber 32. The light bulb 14 may be moved in linear directions 60 with respect to receptacle 10 or rotational directions 62 for insertion/removal of light bulb 14 with respect to receptacle 10.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. A light bulb receptacle comprising:
a housing which defines a housing chamber;
a light bulb socket within the housing chamber and which comprises a first end and a second end about a light bulb chamber which is configured to receive a base of a light bulb;
wherein the light bulb socket further comprises a plurality of fingers which extend outwardly from the first end toward the second end and define an opening to the light bulb chamber at the second end;
wherein the fingers are individually configured to move outwardly from the light bulb chamber during insertion and removal of the light bulb via the opening to the light bulb chamber; and
wherein the fingers individually comprise an engagement member configured to engage a base of the light bulb received within the light bulb chamber and to retain the light bulb received within the light bulb chamber.

2. The receptacle of claim 1 wherein the engagement members are electrically conductive and configured to electrically couple with the base of the light bulb received within the light bulb chamber and which comprises a terminal of the light bulb.

3. The receptacle of claim 2 wherein the fingers are electrically conductive.

4. The receptacle of claim 2 wherein the light bulb socket and the fingers thereof are electrically conductive.

5. The receptacle of claim 4 wherein the housing is electrically insulative.

6. The receptacle of claim 1 further comprising a retaining member about the fingers of the light bulb socket proximate to the second end and the opening to the light bulb chamber.

7. The receptacle of claim 6 wherein the light bulb socket has a cylindrical shape, and the retaining member has a circular shape.

8. The receptacle of claim 7 wherein the retaining member is configured to impede outward movement of the fingers at the second end of the light bulb socket.

9. The receptacle of claim 6 wherein the fingers include a lip proximate to the second end of the light bulb socket to receive the retaining member.

10. The receptacle of claim 6 wherein the retaining member urges the fingers at the second end inwardly to provide engagement of the engagement members with threads of a base of the light bulb received within the light bulb chamber.

11. The receptacle of claim 1 wherein the light bulb socket comprises a circular ring portion proximate the first end, and the fingers extend from the circular ring portion towards the opening at the second end of the light bulb socket.

12. The receptacle of claim 1 wherein the light bulb socket and fingers comprise a single unitary member.

13. The receptacle of claim 1 wherein the light bulb socket comprises a slot proximate the first end to receive a terminal connector configured to be coupled with a terminal of the light bulb received within the light bulb chamber.

14. The receptacle of claim 1 wherein the engagement members are spaced at different distances from the distal ends of the fingers.

15. The receptacle of claim 14 wherein the engagement members are spaced at the different distances from the distal ends of the fingers corresponding to a twist of threads of the base of the light bulb received within the light bulb chamber.

16. The receptacle of claim 1 wherein the housing comprises a first end and a second end about the housing chamber, and wherein the housing is substantially enclosed at the first end of the housing and has an opening proximate to the second end of the housing to receive the light bulb socket.

17. The receptacle of claim 16 wherein the entirety of the housing is a single unitary member.

18. A light bulb receptacle comprising:
an electrically insulative housing which defines a housing chamber;
a light bulb socket within the housing chamber and which comprises a first end and a second end about a light bulb chamber which is configured to receive a base of a light bulb;
wherein the light bulb socket further comprises a plurality of fingers which extend outwardly from the first end toward the second end and define an opening to the light bulb chamber at the second end, and wherein distal ends of the fingers individually include a lip;
wherein the fingers are individually configured to move outwardly from the light bulb chamber during insertion and removal of the light bulb via the opening with respect to the light bulb chamber;
wherein the fingers individually comprise an engagement member configured to engage a base of the light bulb received within the light bulb chamber;
wherein the light bulb socket, the fingers and the engagement members are each electrically conductive and configured to conduct electricity with respect to a terminal of the light bulb received within the light bulb chamber; and
a spring retaining member adjacent to the lips of the fingers of the light bulb socket proximate to the second end of the light bulb socket and configured to urge the distal ends of the fingers inwardly to provide engagement of the engagement members with threads of the base of the light bulb received within the light bulb chamber and to retain the base of the light bulb within the light bulb chamber.

19. A light bulb socket comprising:
a first end and a second end about a light bulb chamber which is configured to receive a base of a light bulb;
a circular ring portion proximate the first end;
a plurality of fingers which extend outwardly from the first end toward the second end and define an opening to the light bulb chamber at the second end;
wherein the fingers are individually configured to move outwardly from the light bulb chamber during insertion and removal of the light bulb via the opening with respect to the light bulb chamber; and
wherein the fingers individually comprise an engagement member configured to engage the base of the light bulb received within the light bulb chamber and to retain the base of the light bulb within the light bulb chamber.

20. The light bulb socket of claim 19 further comprising a spring retaining member proximate to the second end and configured to urge distal ends of the fingers inwardly towards the base of the light bulb received within the light bulb chamber.
